(19) United States
(12) Patent Application Publication
(10) Pub. No.: US 2017/0258217 A1
(43) Pub. Date: Sep. 14, 2017

(54) ELECTRICAL TOOTH BRUSH DEVICE HAVING SUCTION AND RELATED KIT AND METHOD

(71) Applicant: Airway Medix S.A., Warsaw (PL)

(72) Inventors: Oron ZACHAR, Tel Aviv (IL); Yair RAMOT, Kfar Maas (IL); Eizik AMAR, Ashdod (IL)

(21) Appl. No.: 15/454,897

(22) Filed: Mar. 9, 2017

Related U.S. Application Data
(60) Provisional application No. 62/305,706, filed on Mar. 9, 2016.
(60) Provisional application No. 62/305,821, filed on Mar. 9, 2016.
(60) Provisional application No. 62/305,993, filed on Mar. 9, 2016.

(51) Int. Cl. A46B 15/00; A46B 9/04; A46B 9/02; A61C 17/22; A61C 17/34; A46B 13/00; A46B 13/02; A46B 5/00

(52) U.S. Cl. CPC A46B 15/0053; A46B 13/023; A46B 9/04; A46B 15/0044; A46B 5/0033; A61C 17/221; A61C 17/222; A61C 17/3436; A61C 17/3481; A46B 13/005; A46B 9/026; A61C 2204/002; A46B 2200/1066

(57) ABSTRACT

An electrical toothbrush system, device, method and kit are disclosed herein. In some embodiments, the system or device or kit include a suction lumen. In some embodiments, a display-control circuitry is provided, the circuitry configured to cause the display assembly to operate in the first or second display modes according to an elapsed-time-since-most-recent-operation, as measured by the timing circuitry.

### CROSS REFERENCE TO RELATED APPLICATION

This application claims priority to the following U.S. provisional applications, each of which is respectively incorporated herein by reference in its respective entirety: (i) U.S. patent application Ser. No. 62/305,706 filed on Mar. 9, 2016; (ii) U.S. patent application Ser. No. 62/305,821 filed on Mar. 9, 2016; and (iii) U.S. patent application Ser. No. 62/305,993 filed on Mar. 9, 2016.

### FIELD OF THE DISCLOSURE

The present disclosure relates to an electrical toothbrush device having suction, and to a related kit and to a related method.

### SUMMARY OF EMBODIMENTS

An oral care system comprises: a. an electrical motor 116; b. a base assembly 100 comprising: i. an elongated base-assembly main body 110 defining an elongate axis 181; and/or ii. a battery or a battery compartment optionally including electrical contacts for a battery, the battery and/or the battery compartment being electrically wired to the electrical motor 116; c. a head assembly 150, the head assembly comprising: i. an elongated head-assembly main body 160 defining an elongate axis 159 thereof; ii. a sideways-facing brush 165 mounted to the head-assembly main body 160 in a distal half thereof; iii. a suction lumen 170 defining a distal suction-orifice 172, the suction lumen comprising: A. a distal portion 270A disposed within or alongside the head-assembly main body 160 to longitudinally span a majority thereof; and B. a proximal portion 270B that is located proximal to the distal portion 270A, the head assembly 150 being detachably attachable to the base assembly such that when the head and base assemblies 150, 100 are attached to each other: I. the head-assembly main body 160 is disposed distal to the base-assembly main-body 110; and II. the brush is mechanically coupled to the motor 115 so that operation of the motor drives rotation and/or vibration of the sideways-facing brush 165; wherein: i. both the distal 270A and proximal 270B portions of the suction lumen may be completely brought out of contact from the base assembly main body 110 while remaining attached to each other and to the head-assembly main body 160; ii. when the head and base assemblies 150, 100 are attached to each other: A. the proximal 270B portion is within and/or disposed alongside the base assembly main body 110 and longitudinally spans at least a majority thereof; B. an interior of an entirety of the suction lumen 170 is liquid-sealed away from the base assembly main body 110; and C. the base assembly main body 110 is in restraining contact with the proximal portion 270B of the suction lumen 170 via a location 137 disposed on the proximal half of the base assembly main body, so as to restrain at least sideways motion of the suction lumen 170 away from the base assembly main body 110 at the location 137.

In some embodiments, (i) brush bristles of the brush 165 collectively define a bristle-alignment direction 196; and (ii) at an orientation vector 173 of the distal suction orifice is non-parallel to the bristle-alignment direction 196 by at least 10 degrees or at least 20 degrees or at least 30 degrees.

In some embodiments, the motor 116 is disposed within the base-assembly main body.

In some embodiments, further comprising: d. a head shaft lumen 162 at least a portion of which is along or disposed within the head main body 160; e. a head drive shaft 166 at least a portion of which is disposed within the head shaft lumen 162, the head drive shaft mechanically coupled to the brush so that motion (e.g. rotational motion) head drive shaft drives the rotation and/or vibration of the sideways-facing brush 165; f. a base shaft lumen 186 at least a portion of which is along or disposed within the base main body 110; g. a base drive shaft 114 at least a portion of which is disposed within the base shaft lumen, the base drive shaft being mechanically coupled to the electrical motor so that operation of the electrical motor drives motion (e.g. rotational motion).

In some embodiments, further comprising a shaft link 169 (e.g. part of the head drive shaft or the base drive shaft) via which the head drive shaft 166 and the base drive shaft 114 are connected to each other.

In some embodiments, when the head drive shaft 166 and the base drive shaft 114, the shaft link 169 is configured to allow pivoting in a direction perpendicular to the both of the respective elongate axes of the head drive shaft 166 and the base drive shaft 114.

In some embodiments, further comprising a suction lumen connector 171 (e.g. tapered) reversibly connectable to a proximally-disposed source 200 of suction to the suction lumen 170 so that when connected, suction is transmitted from the suction source to the distal suction-orifice 172 via an interior of the suction lumen 170.

In some embodiments, further comprising a suction source proximally disposed to the suction lumen and connected to the suction lumen via a proximal end thereof.

A method of cleaning teeth of a subject within the subject's mouth, the method comprising providing the system of any preceding claim, inserting the brush into the subject's mouth, operating the motor to drive rotational and/or vibrational motion of the brush to brush the subject's teeth, and operating the suction source to transmit negative pressure via the suction lumen to suction matter into the suction lumen via the distal suction orifice 172.

In some embodiments, further comprising timing circuitry configured to measure an elapsed-time-since-most-recent-operation since the motor was last on to drive rotation and/or vibration of the brush.

In some embodiments, further comprising an electronically operated display assembly (e.g. a plurality of LEDs and/or a display screen) having first and second display modes.

In some embodiments, further comprising e. display-control circuitry configured to cause the display assembly to operate in the first or second display modes according to an elapsed-time-since-most-recent-operation, as measured by the timing circuitry, since the motor was last on to drive rotation and/or vibration of the brush.

In some embodiments, the display assembly comprises a red LED and a green LED such that (i) when the display assembly is in the first display mode the red LED is on and the green LED is off and (ii) when the display assembly is in the first display mode the red LED is off and the green LED is on.

In some embodiments, the display-control circuitry causes the display assembly to perform a mode transition from the first to the second display modes to the second of the display modes in response to the elapsed-time-since-most-recent-operation exceeding a pre-determined threshold value.

In some embodiments, the pre-determined threshold value is at least 2 hours or at least 4 hours or at least 6 hours and/or at most 24 hours or at most 12 hours or at most 10 hours.

In some embodiments, further comprising a user control for turning on or turning off the electrical motor and wherein the timing circuitry detects a change of state of the user control.

In some embodiments, the user control is a mechanical switch having first and second switch-states and the timing circuitry measures an elapsed time since the user control was in a given one of the switch-states configured to cause the motor to operate.

A system comprises: An elongate electric toothbrush device (e.g. having head and main body as in the drawings or even a one-piece toothbrush) having a toothbrush body (e.g. the toothbrush body comprises head 160 and base 110 main bodies that are detachably attachable to each other or it could be a one-piece body), an electric motor deployed on or in the toothbrush body and a brush (e.g. sideways-oriented) deployed on the toothbrush body at a distal end thereof, the motor and brush being mechanically coupled to each other so that, when the motor is on, operation of the motor drives rotation and/or vibration of the toothbrush, the electric toothbrush defining an elongate axis; An optional suction lumen oriented along the elongate axis and having a distal lumen located at a distal end of the toothbrush body; and timing circuitry configured to measure an elapsed-time-since-most-recent-operation since the motor was last on to drive rotation and/or vibration of the brush; and an electronically operated display assembly (e.g. attached to and/or deployed onto and/or mounted on—e.g. to main body 160 or to main body 110 (e.g. for the example of FIG. 1A where the display assembly comprises indicators 141, 142) or to a body of a one-piece toothbrush) having first and second display modes; and display-control circuitry configured to cause the display assembly to operate in the first or second display modes according to an elapsed-time-since-most-recent-operation, as measured by the timing circuitry (e.g. since the motor was last on to drive rotation and/or vibration of the brush).

In some embodiments, the display assembly comprises a red LED and a green LED such that (i) when the display assembly is in the first display mode the red LED is on and the green LED is off and (ii) when the display assembly is in the first display mode the red LED is off and the green LED is on.

In some embodiments, the display-control circuitry causes the display assembly to perform a mode transition from the first to the second display modes to the second of the display modes in response to the elapsed-time-since-most-recent-operation exceeding a pre-determined threshold value.

In some embodiments, the pre-determined threshold value is at least 2 hours or at least 4 hours or at least 6 hours and/or at most 24 hours or at most 12 hours or at most 10 hours.

In some embodiments, further comprising a user control for turning on or turning off the electrical motor and wherein the timing circuitry detects a change of state of the user control.

In some embodiments, the user control is a mechanical switch having first and second switch-states and the timing circuitry measures an elapsed time since the user control was in a given one of the switch-states configured to cause the motor to operate.

In some embodiments, the toothbrush body comprises a head body to which the brush is attached and a base portion, wherein (i) the base portion has a battery or battery compartment that is electrically wired to the motor to provide power thereto; and (ii) the head portion is detachably attachable to the base portion.

In some embodiments, the motor is on or in the base portion (e.g. buried inside the base) and is electrically wired to the battery or battery compartment even when the head portion is detached from the base portion.

In some embodiments, the motor is on or in the head portion (e.g. buried inside the head) and is electrically wired to the battery or battery compartment only when the head portion is attached to the base portion.

In some embodiments, the battery or battery compartment is rigidly attached to the timing circuitry, the display assembly and/or the display-control circuitry even when the head portion is detached from the base portion.

In some embodiments, the electric motor has a shaft and/or is mechanically coupled to a shaft having an offset (non-symmetric) mass attached to the shaft. [e.g. an Eccentric Rotating Mass vibration motor, (or ERM, also known as a pager motor is a DC motor with an offset (non-symmetric) mass attached to the shaft.

In some embodiments, the motor is within the base and the offset mass is within the head.

In some embodiments, both the motor and the offset mass are within the head.

A system comprises: An elongate electric toothbrush device having a toothbrush body, a toothbrush head having an elongated neck, a brush (e.g. sideways-oriented) deployed on the toothbrush head at a distal portion thereof, an electric motor deployed in the toothbrush body or in the toothbrush head and, the motor effect movement of the brush either (A) being mechanically coupled to each other so that, when the motor is on, operation of the motor drives rotation and/or oscillation movement of the toothbrush, or (B) the motor driving a vibrator which generates vibration of the head and thereby vibrational motion of the brush; the electric toothbrush defining an elongate axis; A suction lumen oriented along the elongate axis and having a distal lumen located at a distal end of the toothbrush body.

In some embodiments, further comprising: timing circuitry configured to measure an elapsed-time-since-most-recent-operation since the motor was last on to drive rotation and/or vibration of the brush; and an electronically operated display assembly having first and second display modes; and display-control circuitry configured to cause the display assembly to operate in the first or second display modes according to an elapsed-time-since-most-recent-operation, as measured by the timing circuitry, (e.g. time since the motor was last on to drive rotation and/or vibration of the brush).

In some embodiments, the display assembly comprises a red LED and a green LED such that (i) when the display assembly is in the first display mode the red LED is on and the green LED is off and (ii) when the display assembly is in the first display mode the red LED is off and the green LED is on.

In some embodiments, the display-control circuitry causes the display assembly to perform a mode transition from the first to the second display modes to the second of the display modes in response to the elapsed-time-since-most-recent-operation exceeding a pre-determined threshold value.

In some embodiments, the pre-determined threshold value is at least 2 hours or at least 4 hours or at least 6 hours and/or at most 24 hours or at most 12 hours or at most 10 hours.

In some embodiments, further comprising a user control for turning on or turning off the electrical motor and wherein the timing circuitry detects a change of state of the user control.

In some embodiments, the user control is a mechanical switch having first and second switch-states and the timing circuitry measures an elapsed time since the user control was in a given one of the switch-states configured to cause the motor to operate.

In some embodiments, the toothbrush body comprises a head body to which the brush is attached and a base portion, wherein (i) the base portion has a battery or battery compartment that is electrically wired to the motor to provide power thereto; and (ii) the head portion is detachably attachable to the base portion.

In some embodiments, the motor is on or in the base portion (e.g. buried inside the base) and is electrically wired to the battery or battery compartment even when the head portion is detached from the base portion.

In some embodiments, the motor is on or in the head portion (e.g. buried inside the head) and is electrically wired to the battery or battery compartment only when the head portion is attached to the base portion.

In some embodiments, the battery or battery compartment is rigidly attached to the timing circuitry, the display assembly and/or the display-control circuitry even when the head portion is detached from the base portion.

In some embodiments, the electric motor has a shaft and/or is mechanically coupled to a shaft having an offset (non-symmetric) mass attached to the shaft (i.e. is an Eccentric Rotating Mass vibration motor, (or ERM, also known as a pager motor is a DC motor with an offset (non-symmetric) mass attached to the shaft).

In some embodiments, the motor is within the base and the offset mass is within the head.

In some embodiments, both the motor and the offset mass are within the head.

In some embodiments, the brush comprises first and second bristles respectively extending from the toothbrush body in opposite directions, for example, both the extension-direction of the first bristle and the extension-direction of the second bristle are perpendicular to the elongate axis.

In some embodiments, the brush comprises a plurality of bristles having bases deployed around a cross-section of the toothbrush body—for example, each bristle of the plurality being radially aligned to extend out from the toothbrush body.

In some embodiments, first and second bristles of the plurality extend from the toothbrush body in opposite directions, for example, both the extension-direction of the first bristle and the extension-direction of the second bristle are perpendicular to the elongate axis.

In some embodiments, the brush is cylindrically shaped, a central axis of the brush being aligned with and/or collinear with the elongate axis of the brush.

In some embodiments, at least a portion of the motor is deployed within the suction lumen.

In some embodiments, an entirety of the motor is deployed within the suction lumen e.g. supported by ribs connecting the motor to a wall of the suction lumen.

In some embodiments, a first portion of the motor is within the suction lumen and a second portion of the motor is outside of the suction lumen.

In some embodiments, the motor is cylindroid in shape (e.g. having a thickness of at most 10 mm or at most 5 mm or at most 3 mm or at most 2 mm).

In some embodiments, for at least some longitudinal locations of a cross section of the suction lumen the motor occupies at least 5% or at least 10% or at least 25% or at least 50% or at least 75% or a cross section of the suction lumen.

In some embodiments, the suction lumen has a bulge at longitudinal locations wherein at least portion(s) of the motor are within the suction lumen.

In some embodiments, the suction lumen is a vibration motor such that at least one of a (i) a centroid of the motor or (ii) an optional eccentric weight is displayed from a centroid of the side-ways facing brush by at most 20 mm or at most 15 mm or at most 10 mm or at most 7.5 mm or at most 5 mm or at most 3 mm or at most 2 mm, the optional eccentric weight being mounted to a shaft whose rotation around its axis is driven by the electric motor.

In some embodiments, all bristles of the brush are aligned with each other and face to one side of the brush body.

In some embodiments, further comprising a sponge layer on the toothbrush body such that at least some bristles of the brush extend from the sponge layer away from the toothbrush body.

### BRIEF DESCRIPTION OF THE DRAWINGS

FIGS. 1A-1C, 2A-2D, and 3-17 illustrate various devices or components thereof according to different embodiments of the invention.

### DETAILED DESCRIPTION OF EMBODIMENTS

Embodiments of the present invention relate to systems, methods and kits for cleaning the oral cavity and/or teeth of a subject, including but not limited to an intubated subject.

The invention is herein described, by way of example only, with reference to the accompanying drawings. With specific reference now to the drawings in detail, it is stressed that the particulars shown are by way of example and for purposes of illustrative discussion of the preferred embodiments of the exemplary system only and are presented in the cause of providing what is believed to be a useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how several forms of the invention may be embodied in practice and how to make and use the embodiments.

For brevity, some explicit combinations of various features are not explicitly illustrated in the figures and/or described. It is now disclosed that any combination of the method or device features disclosed herein can be combined in any manner—including any combination of features—any combination of features can be included in any embodiment and/or omitted from any embodiments.

In relation to the figures the following numbers indicate:

### Elements of Brush Head Assembly 150

160—head main body

165—brush

170—suction lumen

270A—distal portion of suction lumen 170

270B—proximal portion of suction lumen 170

172—distal orifice of suction lumen 170

171—suction connector

166—head drive-shaft

164—brush transmission

162—head shaft lumen

199—proximal end of head shaft lumen

166—head drive-shaft

167 proximal-facing surface of head main body 160

### Elements of Brush Base Assembly 100

110 base main body

190A distal half of base main body

190B proximal half of base main body

116 motor

149 lumen-restrainer

138 suction switch

112 battery

188 electrical line

114 base drive-shaft

186 base shaft lumen

141, 142—indicators

140 on/off switch (of motor 116)

117 distal-facing surface of base main body 110

### Locations or Axes of Elements of Head Assembly 150

159—Elongate and/or central axis of head main body 160

173—Elongate Axis of the distal portion 270A of suction lumen 170

196—orientation axis of brush 165

103—orientation of suction distal orifice 172

### Locations or Axes of Elements of Base Assembly 100

181—Central and/or elongate axis of brush main body 110

131—more distal restraining location

137—more proximal restraining location

### Additional Elements or Locations or Axis

Stabilizing attachment 139

Shaft link 169

Suction source 200

187—proximal-distal direction

Interface plane 197

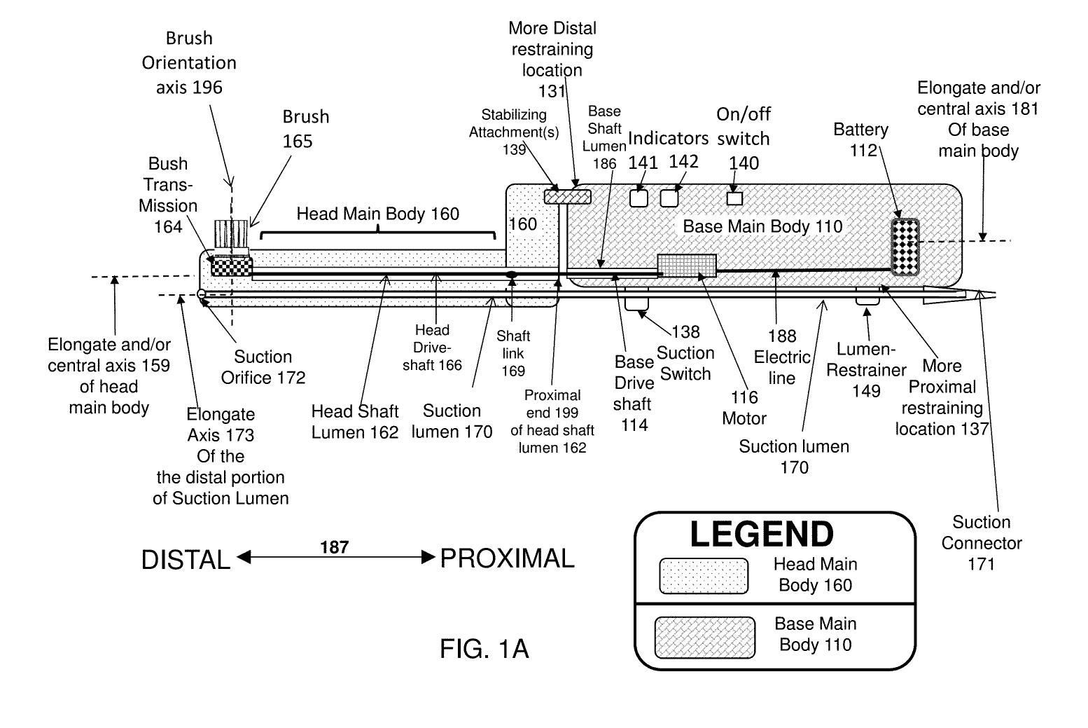

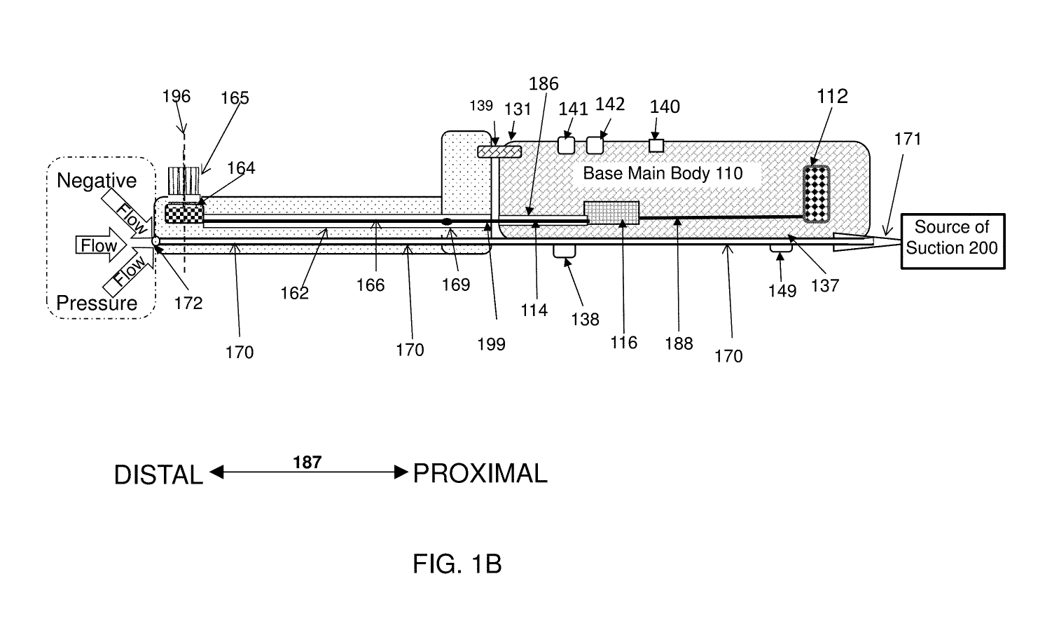

FIG. 1A illustrates a multi-assembly power-brush device for cleaning a subject's teeth where matter (e.g. debris or biofilm) is suctioned into and through a suction lumen 170 (e.g. via suction orifice 172 disposed at a distal end thereof). The power-brush comprises base 100 and head 150 assemblies where head assembly 150 (to which brush 165 is mounted) is detachably attached to a base assembly 100. Whenever the head assembly 150 becomes dirty or is otherwise discarded, the base assembly 100 can be reused with a new ‘replacement’ head assembly 150. As will be discussed below, head assembly 150 comprises head assembly main body 160 and base assembly 100 comprises head assembly main body 110.

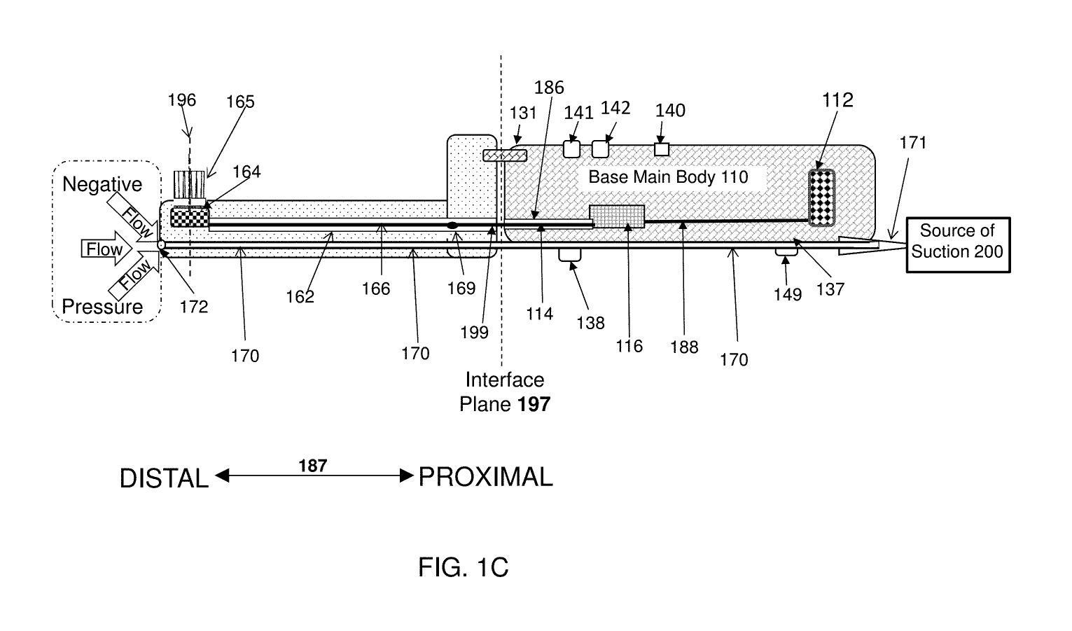

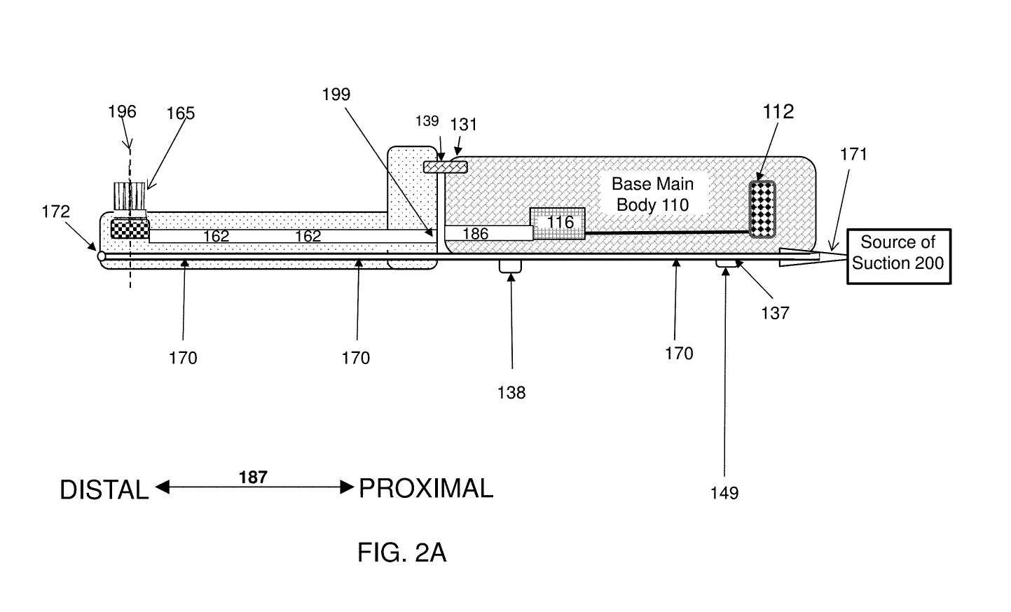

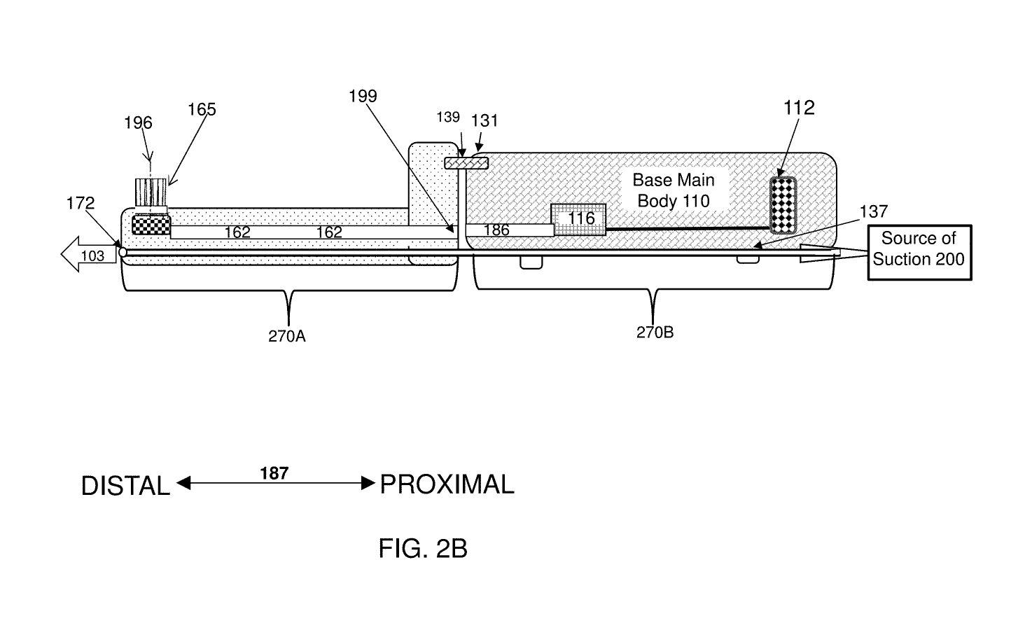

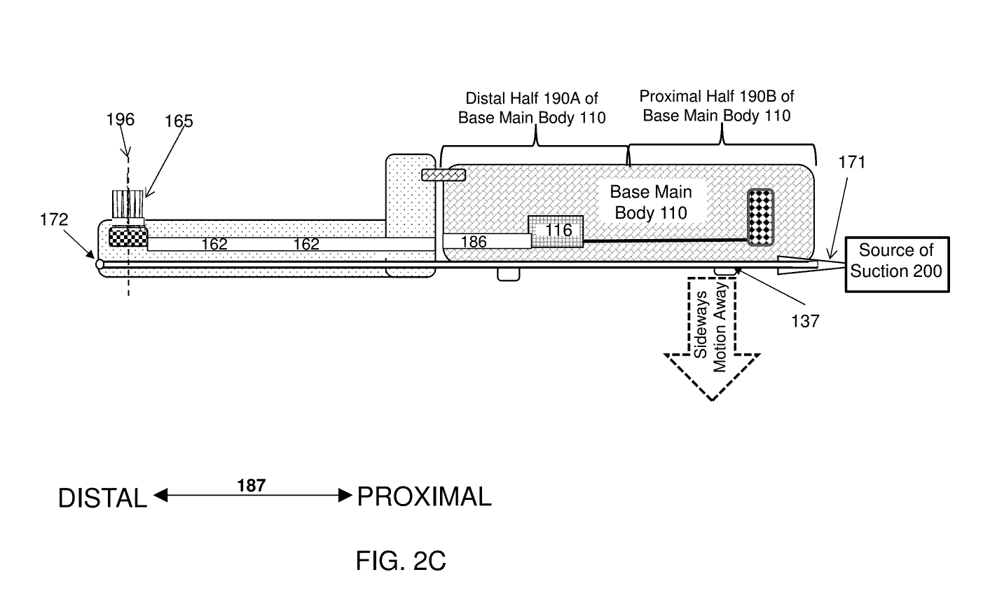

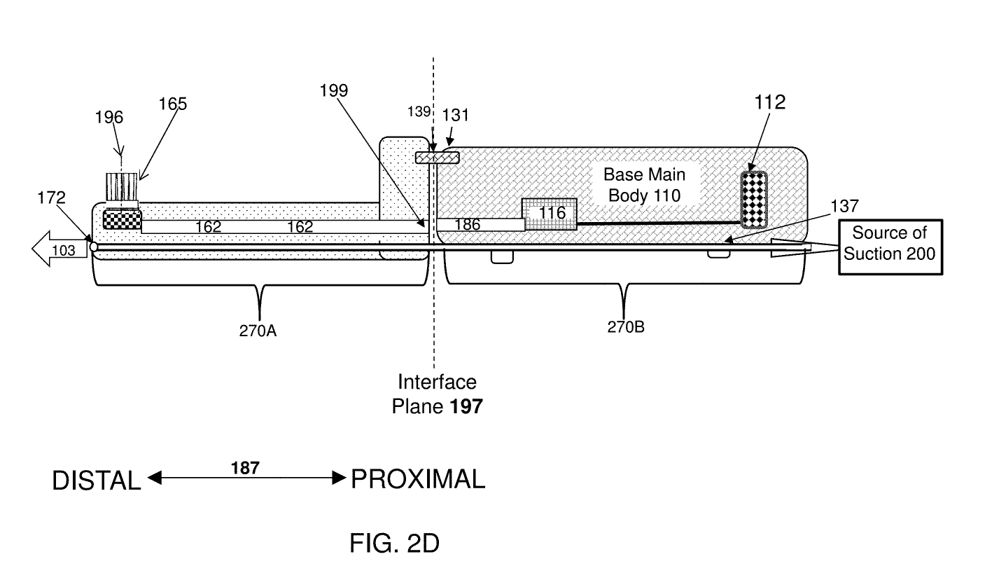

FIG. 1B illustrates the same power brush when a proximal end of suction lumen 170 and/or suction connector 171 (e.g. tapered suction connector) at the suction lumen proximal end is coupled to a suction source 200. FIG. 2A-2C show the same brush as in FIG. 1A where certain elements or labels are removed to further emphasize the various lumens of the brush. In FIG. 2B, three lumen are illustrated—(i) head shaft lumen 162; (ii) base shaft lumen 186 and (iii) suction lumen 170. As shown in FIG. 2B, suction lumen 170 comprises a distal portion 270A and a proximal portion 270B.

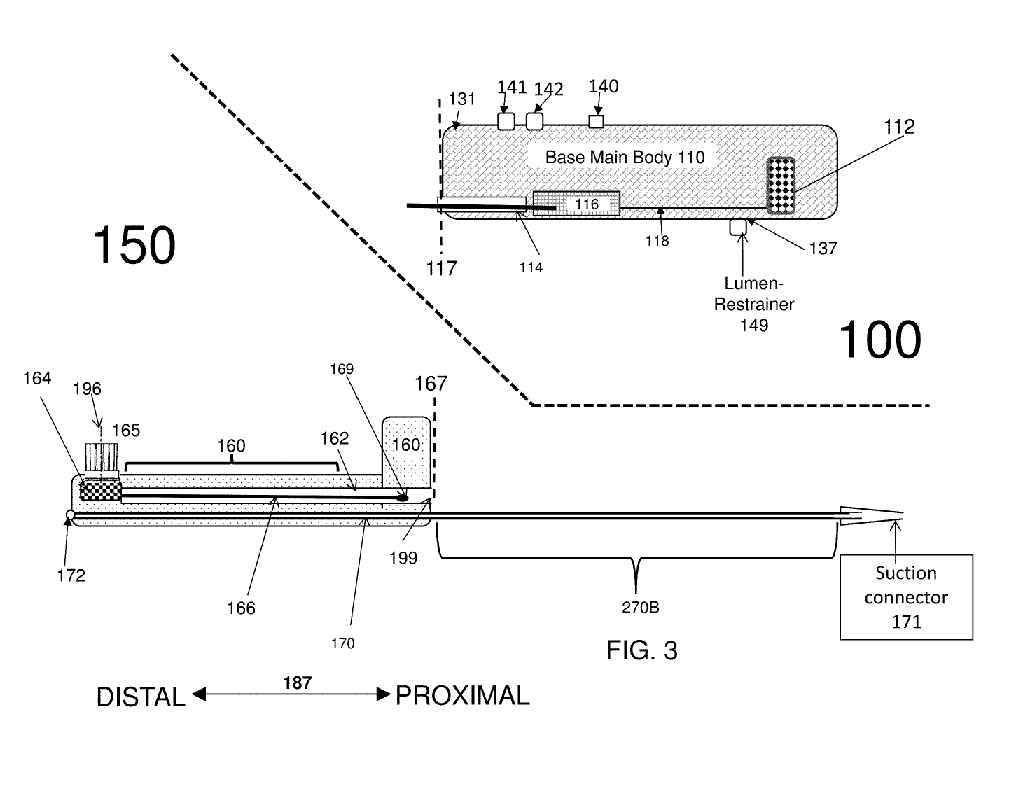

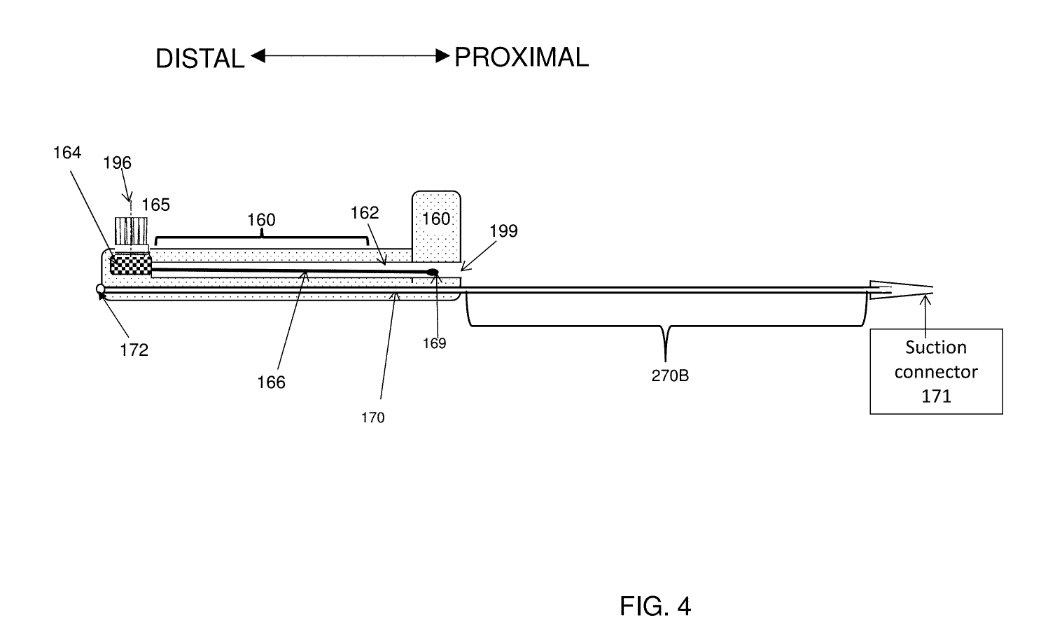

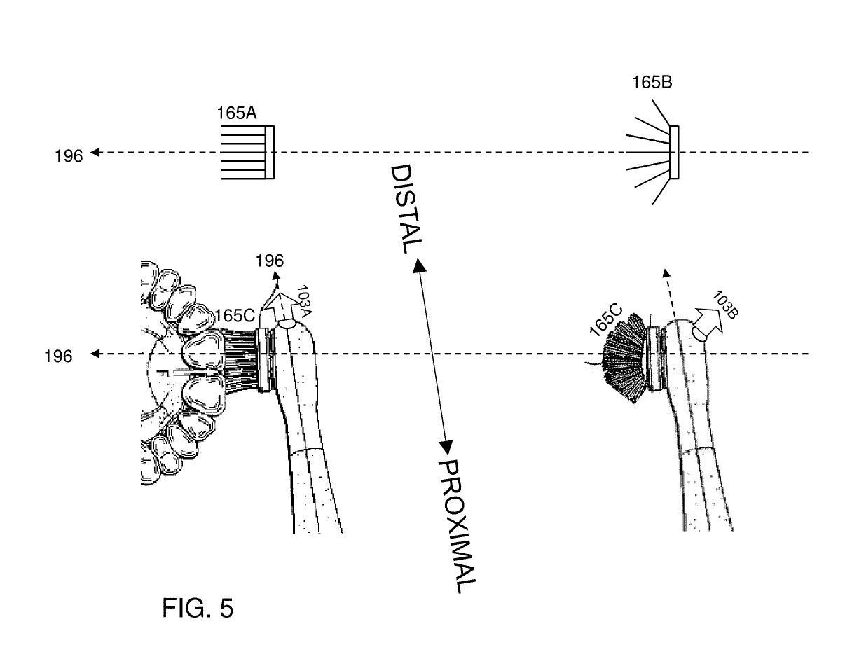

FIG. 3 shows the same brush in a disassembled configuration—one salient feature shown in FIG. 3 (and in FIG. 4) is a ‘tail-like’ proximal portion 270B of suction lumen 170—e.g. proximally extending past main body 160 of head assembly 150. FIG. 5 defines a representative direction 196 of brush 165.

As shown in the figures, the power-brush device comprises head 150 and base 100 assemblies that are detachable attached to each other. The power-brush device cleans both (i) by motion (e.g. rotational and/or vibrational motion) of brush 165 (e.g. by dislodging material on the subject's teeth or gums)—for example, motion induced and/or sustained by an electric motor as known in the art of electric toothbrushes and (ii) by suctioning matter (e.g. debris, cleaning material such as toothpaste or cleaning fluids) into suction lumen 170 via one or more suction-orifice(s) 172 at a distal end of suction lumen 170 and disposed 172 on or alongside a main body 160 of head assembly. Towards this end, a source 200 of negative pressure is disposed at a proximal end suction lumen 170 (e.g. so that negative pressure is detachably attached to a proximate end of suction lumen 170 or to a suction connection 170).

### Potential Design Considerations Related to Some Embodiments

During use of the power-brush device, the head assembly 150 including brush 165 is mounted is typically more exposed to potentially-non-sterile material (e.g. debris or biofilm) than the base assembly 100. As will be discussed below, at least some of this potentially non-sterile material is also proximally transported, through a suction lumen 170) towards and then proximally past base assembly 100.

Embodiments of the present invention relate to two potentially-contradictory design considerations: (i) (DESIGN CONSIDERATION “A”) a desire to minimize exposure of the base assembly 100 to non-sterile material when this material is transported through suction lumen 170 around or past or through the base assembly 100 (ii) (DESIGN CONSIDERATION “B”) a desire to achieve this goal without sacrificing (or with at most a minimum sacrifice of) the overall ‘compactness’ of the power-brush device.

Without limitation and not wishing to be bound by theory, it is possible to achieve these goals by the following features:

I. Although the ‘tail-like’ proximal portion 270B of suction lumen 170 outwardly extends past a proximal end of head assembly mail body 160, the ‘tail-like’ proximal portion 270B of suction lumen 170 is part of the head assembly 150, rather than part of the base assembly 100. Thus, when the device is disassembled into ‘head 150’ and ‘base 100’ constituents (e.g. at a time when suction lumen is disconnected from suction source), the distal portion 270B of suction lumen 170 is detachable from the base-assembly main body 110 (i.e. so it is not directly or indirectly attached from the base-assembly main body 110) while remaining attached (i.e. directly or indirectly) to head-assembly main-body 160. Because the suction lumen 170 may be more exposed to non-sterile material than the base assembly 100, this feature is useful for allowing the potentially less-sterile suction lumen 170 to completely separate from the head-assembly main-body 160—this may be useful for design consideration ‘A.’

II. Furthermore, an interior of an entirety of the suction lumen 170 is liquid-sealed away from the base assembly main body 110. Once again, this protects the base assembly 100 from potentially non-sterile material as the potentially non-sterile material travels proximally through the suction lumen 170. This feature as well may be useful for design consideration ‘A.’

III. As shown in FIG. 1A-1C and 2A-2D, base assembly main body 110 is in “restraining” contact with the proximal portion 270B of the suction lumen 170 (e.g. ‘tail-like’ part of the suction lumen 170) via a ‘proximally disposed’ location 137 of base assembly main body 110. This ‘proximally’ disposed location 137 is disposed on the proximal half of the base assembly main body. The ‘restraining’ contact restrains at least sideways motion (illustrated in FIG. 2C) of the suction lumen 170 away from the base assembly main body 110. This may be useful for design consideration ‘B.’

Thus, in some embodiments, both the distal 270A and proximal 270B portions of the suction lumen may be completely brought out of contact from the base assembly main body 110 while remaining attached to each other and to the head-assembly main body 160;

### Discussion of Head 160 and Brush 160 Main Body

As noted above, the brush may be disassembled into head 150 and base assemblies. Head assembly 150 comprises a head assembly main body 160 ; base assembly 100 comprises base assembly main body 110.

In some embodiments, head main body 160 is elongate. Axis 159, illustrated in FIG. 1A, is an elongate and/or central axis of head main body 160. In some embodiments, base main body 110 is elongate. Axis 181, illustrated in FIG. 1A, is an elongate and/or central axis of base main body 110. As illustrated in the drawings, when the head 150 and base 100 assemblies are in the ‘attached’ configuration (i.e. so that motor 116 drives rotational and/or vibrational motion of brush 165—e.g. via coupled drive shafts 114, 166), then (i) elongate and/or central axis 159 of head main body and (ii) Central and/or elongate axis 181 of brush main body 110 are generally parallel to each other (e.g. possibly but not necessarily co-linear with each other) and aligned with an overall “Distal-proximal” axis 187.

As is common in the art of power toothbrushes, when the power brush is assembled and during operation thereof, head main body 160 is located distal to a brush main body 110.

In some embodiments and as illustrated in FIG. 1A, a proximal location of head main body 160 is attached to a distal location of base main body 110 via stabilizing attachment(s) 139. Stabilizing attachment or any portion thereof may be part of head assembly 150, of base assembly 100, of a combination thereof, or of neither. As is common in the art of the electric toothbrushes, preferably base assembly main body 110 and head assembly main body 160 are rigidly attached to each other. Even though the attachment is rigid, it is reversible to allow for base re-use (i.e. with a new head). As is well-known in the art of the electric toothbrushes, the rigid attachment allows the user to precisely control a location and/or orientation or brush 165 which is mounted (e.g. permanently mounted) to head main body 160.

Any attachment mechanism may be employed—for example, any mechanical mechanism (e.g. fastener, snap, or magnetic mechanism).

Illustrated in FIG. 3 is (i) distal-facing surface 117 of base main body 110; and (ii) proximal-facing surface 167 of head main body 160. The head assembly 150 is detachably attachable to the base assembly such that when the head and base assemblies 150, 100 are attached to each these two surfaces 117, 167 face each other—e.g. in contact with each or facing each other with a gap (for example, a relatively ‘small’ gap of at most 5 mm or at most 3 mm or at most 1 mm) separating between these two surfaces 117, 167.

FIG. 1C shows interface plane 197. Interface plane 197 necessarily is perpendicular to distal-proximal axis 187 and is obtained by (i) computing the best plane (i.e. plane constrained to be perpendicular to distal-proximal axis 187) of a mediating surface (i.e. halfway between) the i) distal-facing surface 117 of base main body 110; and (ii) proximal-facing surface 167 of head main body 160. Interface plane 197 is also illustrated in FIG. 2D.

### Driving Motion of Brush 165

As is known in the art of electric toothbrushes and in the non-limiting example of the drawings, motion (e.g. vibrational and/or translational motion) of brush 165 may be provided by the following elements in combination with each other: (i) head-drive shaft 166, at least a portion of which is within head shaft lumen 162; (ii) base-drive shaft 114 at least a portion of which is within base shaft lumen 186; (iv) shaft link 169 (v) brush shaft transmission 164; (vi) electric motor 116 and (vi) battery 112.

Electric motor 116 (e.g. electrically powered by current received from battery 112 via electric line 188) forces longitudinal motion (e.g. reciprocating motion) base shaft drive shaft 114 within base shaft lumen 186. In some embodiments, motor 116 is disposed within the base-assembly main body 110.

Because base shaft drive shaft 114 is rigidly attached to head-drive shaft 166 (e.g. detachably attached and/or attached via shaft link 169), this longitudinal motion of base drive shaft 114 causes longitudinal motion of head-drive shaft 166 in head shaft lumen 162. There is no requirement for an entirety of base shaft drive shaft 114 to be within base shaft lumen 186—in some embodiments, only a portion of base shaft drive shaft 114 is disposed within base shaft lumen 186 (e.g. so a distal portion of base shaft drive shaft 114 distally protrudes from base shaft lumen 186). In fact, this is the situation illustrated in FIG. 1A where a portion of base drive shaft 114 is disposed within head shaft lumen 162—in addition, in the example of FIG. 1A shaft link 169 is disposed in head shaft lumen 162.

There is no requirement for an entirety of head shaft drive shaft 166 to be within head shaft lumen 162—in some embodiments (NOT SHOWN), only a portion of head shaft drive shaft 166 is disposed within head shaft lumen 162 (e.g. so a proximal portion of head shaft drive shaft 166 proximally protrudes from head shaft lumen 162—for example, past a proximal end 199 of head shaft lumen.

As noted above, motor 116 is mechanically coupled to head drive-shaft 166 (e.g. via base drive shaft 114 and shaft link 169) to induce longitudinal motion (e.g. reciprocating motion) of head drive-shaft 166. In some embodiments and as is well-known in the art of electrical toothbrushes, this longitudinal motion is converted into vibrational and/or rotational motion of brush 165—e.g. head drive-shaft 166 is mechanically coupled to brush 165—for example, via brush transmission 164.

In some embodiments, head-assembly shaft lumen 162 has a length Li of which alongside is or formed within the head-assembly main body 160 and oriented along the elongate and/or central axis 159 thereof.

### Suction Lumen 170

In some embodiments, in addition to conventional ‘electrical toothbrush’ functionality, the power toothbrush provides a ‘suctioning functionality’—for example, to remove matter (e.g. debris or biofilms) from the subject's mouth.

As illustrated in the figures, suction orifice 172 is a distal opening of suction lumen 170—thus suction lumen 170 may be said to define a distal suction-orifice 172 disposed at a distal end of suction lumen 170.

As shown in FIG. 1B, when a proximal end of suction lumen 170 is connected to suction source 200 (for example, via connected 171) negative pressure is transmitted from suction source 200 via suction lumen 170 to a region outside of suction orifice 172. This induces a flow of air and optionally additional material (e.g. potentially non-sterile material) into suction lumen 170 via suction orifice 172. In particular, this transmitted negative pressure causes this potentially non-sterile material to entered into suction lumen 170 via suction orifice 172, traverse the suction lumen 170 (i.e. an interior thereof) and to proximally exit the suction via a proximal end of suction lumen 170.

In some embodiments, at the other end (i.e. proximal end) of suction lumen 170 is suction connector 171—for example, the proximal end of suction lumen 170 is connected via the suction connector 171. In some embodiments, suction connector 171 is a tapered connector, tapered in the proximal direction. Suction connector 171 may be permanently attached to suction lumen 170 (e.g. integrally formed with) or detachable attached to suction lumen 170 at a proximal end thereof. For example, a kit may comprise suction lumen 170 and suction connector 171 as separate elements and the suction connector 171 is attached to (e.g. mounted onto) suction lumen 170 at a proximal end thereof.

As shown in FIG. 2B, suction lumen 170 comprises a distal portion 270A and a proximal portion 270B. For example, the distal portion 270A is disposed within or alongside the head-assembly main body 160 (e.g. suction lumen 170 longitudinally spans at least a majority (e.g. at least 75% of) of head-assembly main body 160 (i.e. a length thereof)). As shown in FIG. 1D, when the head 150 and base 100 assemblies are coupled to each other, the distal portion 270B of suction lumen 170 is distal to interface plane 197.

By definition, proximal portion 270B that is located proximal to the distal portion 270A. As shown in FIG. 1D, when the head 150 and base 100 assemblies are coupled to each other, the proximal portion 270A of suction lumen 170 is proximal to interface plane 197. In some embodiments, at least 75% or at least 90% of an entirety of the entire proximal portion 270B is proximal to a proximal end 199 of head shaft lumen 162. In some embodiments, at least 75% or at least 90% of an entirety of the entire proximal portion 270B is proximal to interface plane 197

In some embodiments, the proximal 270B and distal 270A portions of the suction lumen 170 are permanently attached to each other. Alternatively, they are detachably attachable to each other.

Head-assembly shaft lumen 162 has a length Li of which alongside is or formed within the head-assembly main body 160 and oriented along the elongate and/or central axis 159 thereof.

In some embodiments, L₂ is a length of distal portion 270A of suction lumen 170, L₃ is a length of proximal portion 270B of suction lumen 170.

In some embodiments, a length ratio L₃/L₁ is at least 0.5 or at least 0.75 or at least 1 or at least 1.25 or at least 1.5. Alternatively or additionally, a ratio (L₂+L₃)/L₁ is at least 1 or at least 1.25 or at least 1.4 or at least 1.5 or at least 1.75 or at least 2.

In some embodiments, A. the proximal portion of the suction lumen is: i. attached to both the distal portion of the suction lumen and to the brush-head main body; and can remain attached to the head main body 160 while being detached from the base main body.

### A Discussion of Brush 165

Also illustrated in the figures is a sideways-facing brush 165 mounted to the head-assembly main body 160—for example, mounted to a distal half of head-assembly main body 160. As will be discussed below, bristles of the brush 165 collectively defining a bristle-alignment direction 196.

As is known in the art of toothbrushes, brush 165 comprises an array of bristles—in non-limiting embodiments, a width of each bristle is at most 0.25 mm or at most 0.1 mm and/or length of each bristles is at most 2 cm or at most 1.5 cm or at most 1 cm.

In some embodiments and as illustrated by brushes 165A (schematic illustration) and 165C (more accurate illustration of an actual brush) of FIG. 5, the bristles are parallel to each other—in these cases all bristles are aligned both with each other and also with brush orientation axis 196 defining a representative orientation/direction (e.g. average orientation/direction) of the bristles of the brush. In other examples, and as illustrated by brushes 165B (schematic illustration) and 165D (more accurate illustration of an actual brush) of FIG. 5, the bristles are not necessarily parallel to each other—however, even in this situation the bristles collectively define a brush orientation axis 196 which is a representative orientation/direction (e.g. average orientation/direction) of the bristles of the brush.

As illustrated in the figures, brush 165 (i.e. whose orientation is defined by brush orientation axis 196) is sideways-facing relative to a proximal-distal and/or to a central axis 159 of the head main body 160.

One salient feature provided by some embodiments of the invention relates to relative orientations of (i) orientation vector 173 of distal suction-orifice 172 (discussed above); and (ii) bristle-alignment direction 196. In some embodiments, orientation vector 173 is non-parallel to bristle-alignment direction 196 so that an angle □□ between orientation vector 173 and bristle-alignment direction 196 is non-zero. In different embodiments, this angle □□ is at least 10 degrees or at least 20 degrees or at least 30 degrees. For the present disclosure, if this angle is defined as at least “X” degrees (where “X” is a positive number less than 90) this means that the angle □□ is between “X” degrees and 90 degrees.

In the particular example illustrated the drawings, orientation vector 173 and bristle-alignment direction 196 are perpendicular to each other.

### Indication of Time Since Most Recent Use

In some embodiments, the device includes a display assembly (e.g. a display screen or a plurality of indicators—e.g. 141/142 which may be mounted to the base as shown in the drawings or to the head—in another example, the display assembly is mounted to a one-piece electric toothbrush or any toothbrush that does not rely on the head/base that are detachable from each other).

Immediately after use (i.e. after the motor is shut off), the display assembly has a first mode—e.g. a ‘green’ indicating that the brush was last used relatively recently and that there is no current need to brush the subject's teeth. At a later time, the display assembly may indicate that the amount of time since the most recent use is ‘too long’ (e.g.

exceeded some sort of pre-set threshold—e.g. about 6 hours or about 8 hours or about 10 hours). At that point, the display assembly may transition from the first mode (e.g. green indicating that ‘the situation is good’ and that there is no need to brush teeth) to a second mode (e.g. red indicating that in fact there is need to operate the brush again to brush the subject's teeth). Thus, in some embodiments, timing circuitry (NOT SHOWN) (e.g. implemented as analog or digital electronics and/or in software) measures the elapsed time since the most recent brush use—e.g. the most recent time since the motor was shut off (e.g. by a user control such as a switch 140 which may be located anywhere—e.g. on base main body 110 or on head main body 160 or anywhere on a multi-piece or single piece electrical toothbrush). Thus in one example, in response to the user shutting off the motor (e.g. using a manual switch or in any other manner—e.g. a user puts down the brush and a sensor responds by shutting off the motor), the timing circuitry ‘begins’ to count the elapsed time since this happened.

In the example of FIG. 1A there are multiple LEDs—alternatively a single LED may change colors, or a display screen may be provided.

Until the amount of time reaches a threshold (e.g. immediately after brush usage), the display assembly may remain in a first state (e.g. green LED illuminated. Once the amount of time exceeds a threshold (e.g. a pre-determined value) (e.g. as measured by timing circuitry) this may be detected and in response the display assembly may perform a display transition—e.g. a red LED is shut off and a green LED turned on, or the LED color changes, or the display screen adopts a new state.

In some embodiments, display control circuitry (e.g. operatively linked to the timing circuitry to receive input therefrom) regulates a display state of the display screen.

In some embodiments, the timing circuitry and/or display control circuitry receives power from the battery even when the motor is shut off. For example, a switch may have 3 mode—(i) motor on [MODE A] (ii) entire device off (i.e. including timing and/or display control circuitry [MODE B] and (iii) motor off but circuitry receiving power from the battery and on (e.g. display optionally on) [MODE C]. In another example, there may be only two modes—MODES A and C without MODE B where the only way to get MODE B is to disconnect the battery.

Although this ‘display assembly’ and ‘display mode’ invention is explained in the context of a toothbrush having a head and a base, it is appreciate that his may apply to any electrical toothbrush including those having a suction lumen and those lacking a suction lumen.

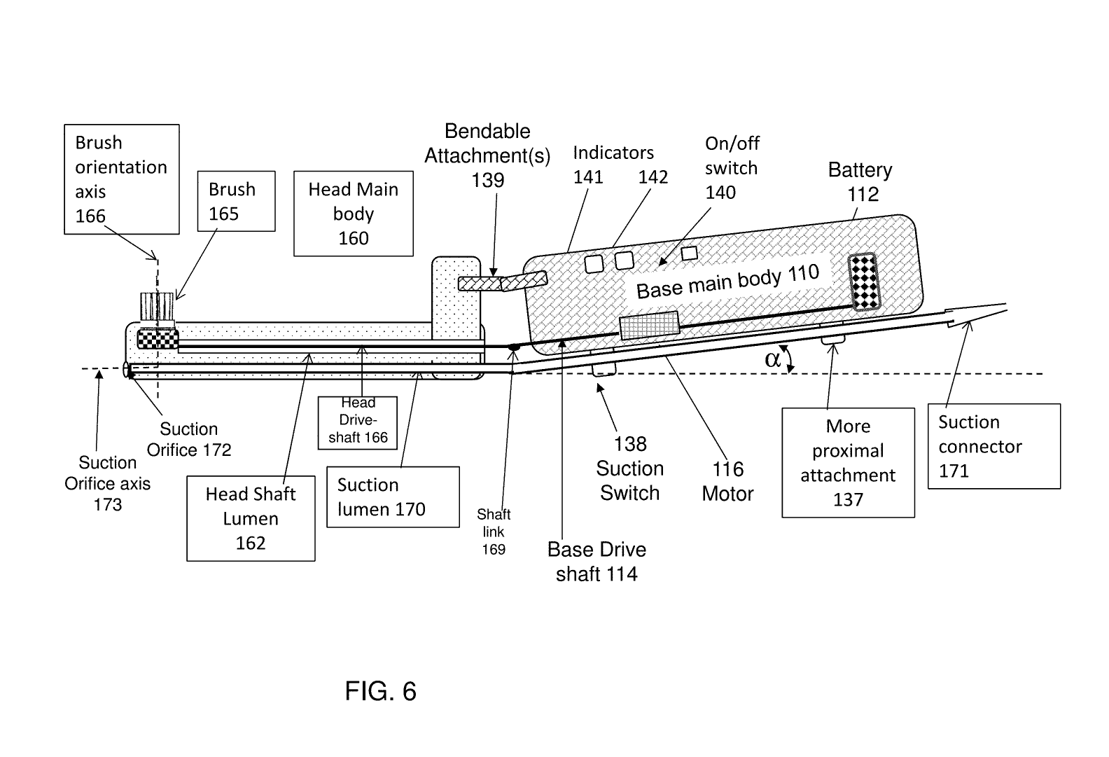

### Discussion of FIG. 6

In some embodiments, the device is bendable—e.g. instead of an elongate and/or central axis 181 of base main body 110 remaining aligned with (e.g. parallel to) an elongate axis 159 of head main body 160, they can bend and/or pivot relative to each other.

For example, the head drive shaft 166 and the base drive shaft 114 are connected to each other via shaft link 169, and the shaft link 169 is configured to allow pivoting in a direction perpendicular to the both of the respective elongate axes of the head drive shaft 166 and the base drive shaft 114. FIG. 6 shows bending and/or pivoting (e.g. around shaft link 169) by an angle alpha.

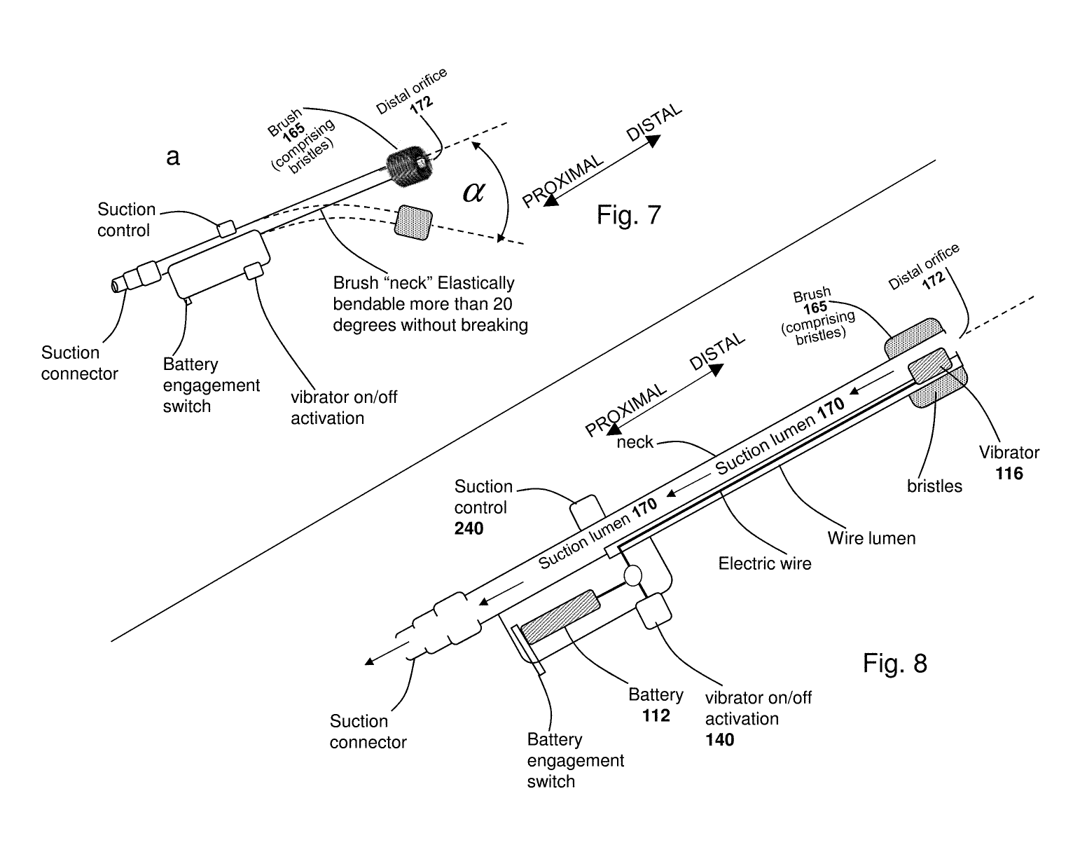

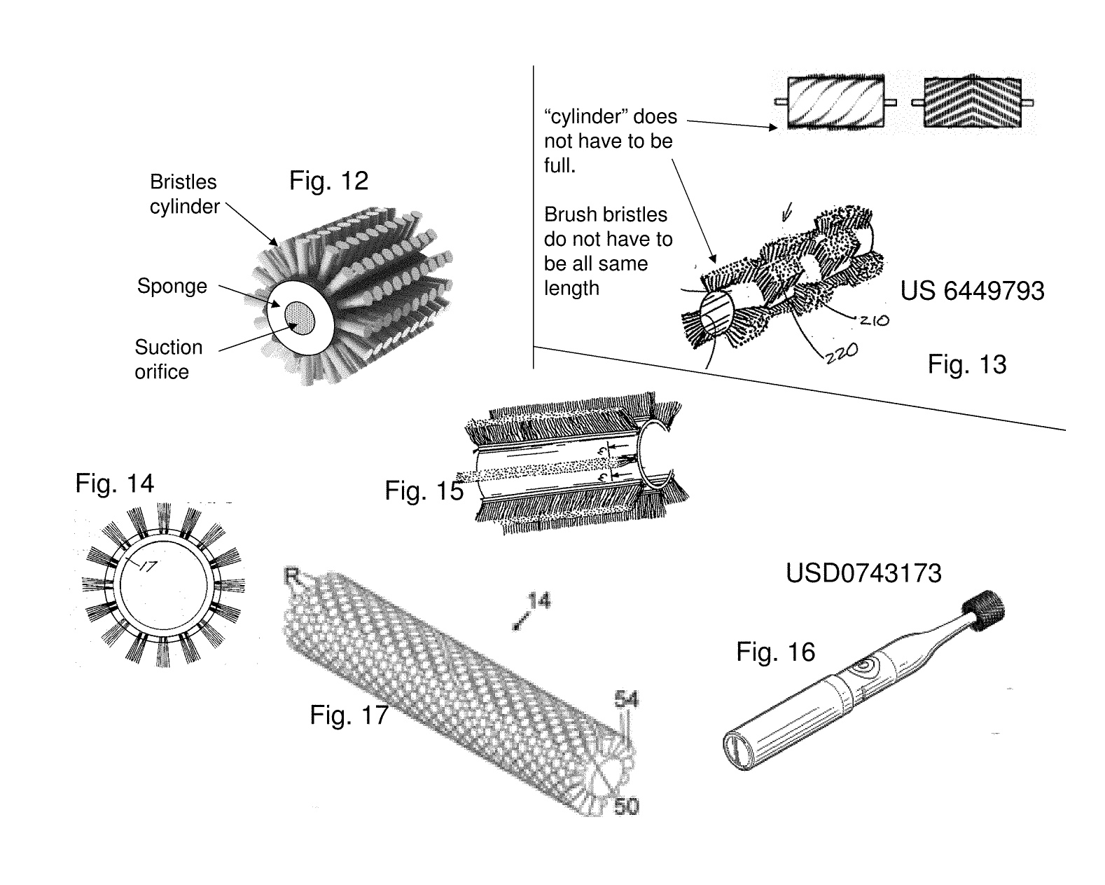

### Discussion of FIGS. 7-17

FIGS. 7-8 illustrate an electric toothbrush device having a brush 165 (e.g. comprising an array of bristles) deployed around an exterior suction lumen 170 which may serve as a portion for a toothbrush body. An electric vibrator (e.g. electric motor having shaft and/or is mechanically coupled to a shaft having an offset (non-symmetric) mass attached to the shaft. (is an Eccentric Rotating Mass vibration motor, (or ERM, also known as a pager motor is a DC motor with an offset (non-symmetric) mass attached to the shaft]) receives current from a battery 112—e.g. via an electric wire deployed in a wire lumen.

Operation of the electric motor causes vibration of a brush 165 of the toothbrush—e.g. bristles of brush 165 have properties known in the art of toothbrushes. In some embodiments, a vibrator on/off activation device (e.g. a switch) may be used to turn on or off the motor. A suction connector (e.g. tapered) is disposed at a proximal end of suction lumen 170. When suction connector is connected to a suction source and/or suction lumen 170 is connected to a suction source (i.e. proximal to the suction lumen), negative pressure is transmitted through suction lumen 170 to cause matter to enter into suction lumen 170 via a distal lumen 172 thereof so that the matter proximally flows through suction lumen 170—this may be used to suction out material (e.g. non-sterile material and/or biofilm) out of a subject's mouth.

In some embodiments, brush is cylindrical in shape (e.g. full cylinder or partial cylinder). As shown in FIG. 8 a portion or an entirety of vibrator is deployed within suction lumen 170. In some embodiments the thickness of suction lumen 170 is not uniform—e.g. there is a bulge at locations where the vibrator is present. In some embodiments, vibrator is within suction lumen at locations along a ‘longitudinal dimension’ of elongated suction lumen 170 where bristles are present.

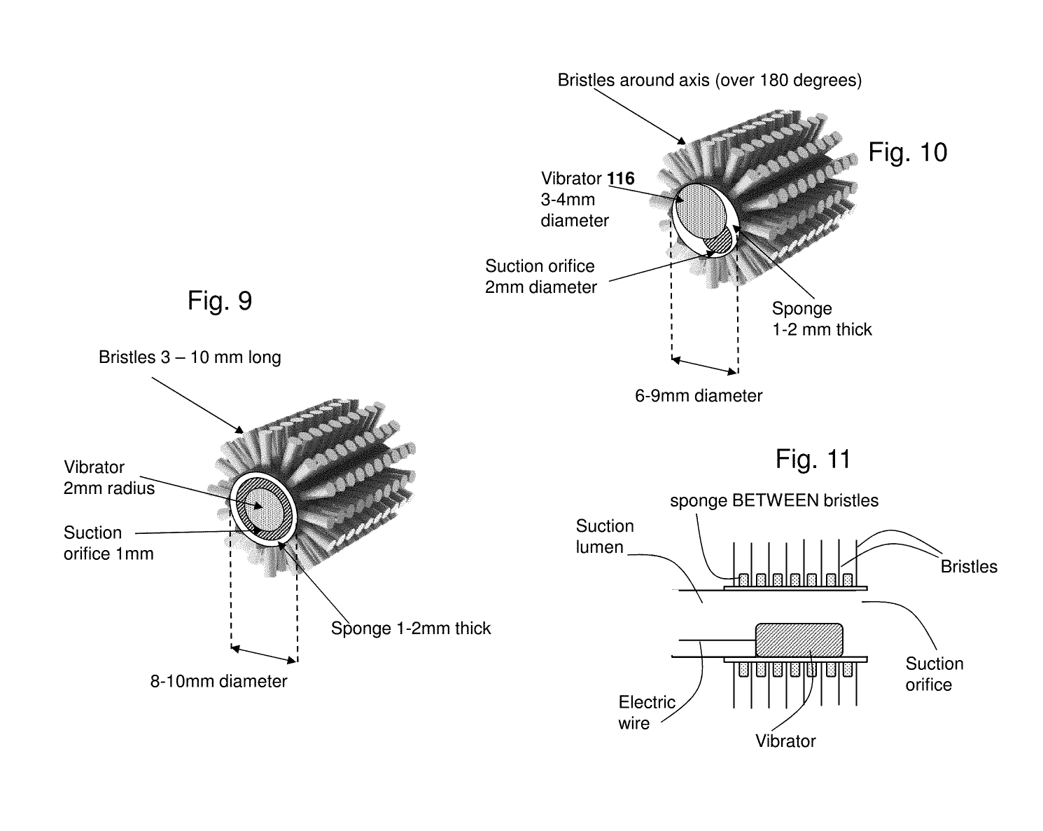

FIG. 9 and FIG. 10 relate to different embodiments. In FIG. 9 an entirety of the vibrator is within the suction lumen 170—e.g. held therein by ribs so that when the electric vibrator vibrates, vibrations are transmitted from the electric vibrator to the brush to induce vibrations of the brush. In FIG. 10 only a portion of the vibrator is within the suction lumen—e.g. a centerline of the vibrator in FIGS. 9-10 is aligned (e.g. parallel to) with a centerline of the suction lumen 170 however in FIG. 9 the centerlines of the vibrator and the suction lumen 170 may correspond and in FIG. 10 the centerline of the vibrator may be ‘shifted’ away from the centerline of the suction lumen.

In some embodiments, the vibrator is cylindroid and/or cylindrical in shape.

FIG. 11 is a side-view in contrast to the ‘perspective views’ of FIGS. 9-10. In some embodiments, the bristles extend from a sponge layer—e.g. on the toothbrush body such that at least some bristles of the brush extend from the sponge layer away from the toothbrush body. This concept of ‘extending from a sponge’ may also exist for brushes where the bristles are aligned with each other as well (not shown).

FIGS. 12-17 show additional examples.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to. The term “or” is used herein to mean, and is used interchangeably with, the term “and/or,” unless context clearly indicates otherwise. The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

1. An oral care system comprising:
a. an electrical motor 116;
b. a base assembly 100 comprising:
i. an elongated base-assembly main body 110 defining an elongate axis 181; and/or
ii. a battery or a battery compartment optionally including electrical contacts for a battery, the battery and/or the battery compartment being electrically wired to the electrical motor 116;
c. a head assembly 150, the head assembly comprising:
i. an elongated head-assembly main body 160 defining an elongate axis 159 thereof;
ii. a sideways-facing brush 165 mounted to the head-assembly main body 160 in a distal half thereof;
iii. a suction lumen 170 defining a distal suction-orifice 172, the suction lumen comprising:
A. a distal portion 270A disposed within or alongside the head-assembly main body 160 to longitudinally span a majority thereof; and
B. a proximal portion 270B that is located proximal to the distal portion 270A,
the head assembly 150 being detachably attachable to the base assembly such that when the head and base assemblies 150, 100 are attached to each other:
I. the head-assembly main body 160 is disposed distal to the base-assembly main-body 110; and
II. the brush is mechanically coupled to the motor 115 so that operation of the motor drives rotation and/or vibration of the sideways-facing brush 165;
wherein:
i. both the distal 270A and proximal 270B portions of the suction lumen may be completely brought out of contact from the base assembly main body 110 while remaining attached to each other and to the head-assembly main body 160;
ii. when the head and base assemblies 150, 100 are attached to each other:
A. the proximal 270B portion is within and/or disposed alongside the base assembly main body 110 and longitudinally spans at least a majority thereof;
B. an interior of an entirety of the suction lumen 170 is liquid-sealed away from the base assembly main body 110; and
C. the base assembly main body 110 is in restraining contact with the proximal portion 270B of the suction lumen 170 via a location 137 disposed on the proximal half of the base assembly main body, so as to restrain at least sideways motion of the suction lumen 170 away from the base assembly main body 110 at the location 137.

2. The system of claim 1 wherein: (i) brush bristles of the brush 165 collectively define a bristle-alignment direction 196; and (ii) at an orientation vector 173 of the distal suction orifice is non-parallel to the bristle-alignment direction 196 by at least 10 degrees or at least 20 degrees or at least 30 degrees.

3-17. (canceled)

18. A system comprising:
a. An elongate electric toothbrush device having a toothbrush body an electric motor deployed on or in the toothbrush body and a brush deployed on the toothbrush body at a distal end thereof, the motor and brush being mechanically coupled to each other so that, when the motor is on, operation of the motor drives rotation and/or vibration of the toothbrush, the electric toothbrush defining an elongate axis;
b. An optional suction lumen oriented along the elongate axis and having a distal lumen located at a distal end of the toothbrush body; and
c. timing circuitry configured to measure an elapsed-time-since-most-recent-operation since the motor was last on to drive rotation and/or vibration of the brush; and
d. an electronically operated display assembly having first and second display modes; and
e. display-control circuitry configured to cause the display assembly to operate in the first or second display modes according to an elapsed-time-since-most-recent-operation, as measured by the timing circuitry.

19. The system of claim 18 wherein the display assembly comprises a red LED and a green LED such that (i) when the display assembly is in the first display mode the red LED is on and the green LED is off and (ii) when the display assembly is in the first display mode the red LED is off and the green LED is on.

20-57. (canceled)
